(19) United States
(12) Patent Application Publication
(10) Pub. No.: US 2005/0027610 A1
(43) Pub. Date: Feb. 3, 2005

(54) Electronic commerce systems and methods providing unified checkout steps

(76) Inventor: Brian K. Wharton, Hermosa Beach, CA (US)

Correspondence Address: PARSONS BEHL & LATIMER, ONE UTAH CENTER, 201 SOUTH MAIN STREET SUITE 1800, SALT LAKE CITY, UT, 84145-0898, US

(21) Appl. No.: 10/837,498

(22) Filed: Apr. 30, 2004

Related U.S. Application Data
(63) Continuation of application No. 09/383,279, filed on Aug. 26, 1999.

(51) Int. Cl. G06F 17/60

(52) U.S. Cl. 705/26

(57) ABSTRACT

Components of E-Commerce systems and methods for providing a unified checkout step for several aggregated vendor commerce systems.

### CROSS-REFERENCE TO RELATED APPLICATIONS

This application is a continuation of prior U.S. application Ser. No. 09/383,279 filed Aug. 26, 1999.

### BACKGROUND

1. Technical Field

The disclosed systems are related to the field of electronic commerce (“E-Commerce.”) More specifically, the disclosed systems relate to systems and methods for conducting electronic commerce in a multiple-vendor environment, such as in an electronic mall or through an electronic portal.

2. Description of the Related Art

Electronic shopping systems are known in the art, and more recently E-Commerce shopping systems implemented over a wide-area network, such as the Internet, have become pervasive. In the past, these systems have suffered from many disadvantages, both from the vendor's (or merchant's) perspective, and from the customer's perspective. One problem with these systems relates to the logistical difficulties in maintaining and operating an online shopping system. These difficulties, such as payment verification, accounting/billing, order fulfillment, etc., can prove to be very expensive for medium and small-sized vendors seeking to establish on online presence.

Another problem of these systems has been difficulty in consolidating or aggregating product data from multiple vendors so that customers can simultaneously shop from multiple vendor platforms. In this field, it is desirable to provide a framework where a customer can (in one electronic shopping trip) purchase one item from one vendor, and then immediately purchase another item from a different vendor and yet have a single integrated checkout and a single transaction validation process.

Known attempts at aggregating product data in order to deliver a unified shopping experience have included what are known as “aggregation” systems. In these systems, the aggregator sets up a single E-Commerce platform that includes a massive database for storing product data from numerous vendors. These types of systems, however, suffer from many disadvantages. First, many established vendors do not favor these systems because the vendors essentially lose control of their E-Commerce solution. Many vendors have invested large amounts of time and money in perfecting their own E-Commerce systems, and, therefore, they are reluctant to turn control of their electronic shopping experience to a third party (the aggregator), who then is responsible for maintaining the quality and efficiency of the vendor's E-Commerce solution. Second, many vendors want to have the flexibility of maintaining their own business rules that apply to their customers. To produce a single E-Commerce system that accommodates all of the business rules of a plurality of vendors is an enormous task, and one that is not easily achieved. Third, most vendors want to retain control over their product catalog and customer directory. If the product catalog is maintained by the aggregator system, then the catalog may not be as current or complete as the vendor desires. Moreover, from the aggregator's perspective, it may be very difficult to deal with the massive amount of data coming from the variety of vendors that are aggregated on its system, whose data are likely in different formats that all must be reformatted in order to work together within the single aggregation system. For at least these reasons, as well as others, these types of E-Commerce frameworks have achieved only limited success.

Thus, there has been a need for an E-Commerce framework that satisfies the needs of customers by providing a single, unified shopping experience, that also satisfies the needs of vendors by allowing them to retain control of their product and customer databases while relieving them of the logistical difficulties in operating an E-Commerce system.

### BRIEF SUMMARY

Some of the disclosed systems provide an E-Commerce system and method for providing a single, unified back-end transaction processing system coupled to a plurality of vendor commerce systems through an E-Commerce portal. The vendor commerce systems may include local catalog and customer data, as well as a local shopping basket and local business rules that are specific to a particular vendor. The unified back-end processor may include software programming for interfacing to numerous back-end processing systems, such as payment verification, accounting/billing and order fulfillment systems. Also optionally included at the back-end processor are a variety of data storage devices for storing merchant-specific and customer-specific transaction processing information, and also a global shopping basket for storing transaction order items that are generated during a customer interaction with the plurality of vendor commerce systems associated with the E-Commerce system. A unique payment proxy system for interfacing the back-end transaction processing system to a plurality of payment verification systems may also provided.

An exemplary E-Commerce system is further disclosed that includes a plurality of vendor commerce systems; a plurality of back-end processing systems for processing transaction requests generated by the plurality of vendor commerce systems; and a transaction processor coupled between the plurality of vendor commerce systems and the plurality of back-end processing systems, wherein the transaction processor includes a global shopping basket for storing transaction information generated by the plurality of vendor commerce systems, and a back-end processor interface for processing and routing the stored transaction requests to the plurality of back-end processing systems.

An exemplary method is also disclosed for conducting E Commerce, comprising the steps of (A) connecting to an E-Commerce portal; (B) linking from the E-Commerce portal to a vendor commerce system associated with the E-Commerce portal; (C) browsing a local catalog of products stored at the vendor commerce system and selecting a particular product for purchase; (D) transmitting a transaction packet from the vendor commerce system to a common transaction processing system via the Internet, and storing the transaction packet in a global shopping basket; (E) returning to step (A) and repeating steps (B), (C) and (D) until no additional products are to be purchased; (F) segmenting the transaction packet information stored in the global shopping basket and aggregating individual product order items by vendor; and (G) processing the individual product order items for each vendor at the transaction processing system by communicating transaction information between the transaction processing system and a plurality of back-end processing systems.

Some of the disclosed systems provide a payment proxy system for use with an online transaction processor, comprising: a payment proxy interface for communicating information to and from the transaction processor; runtime payment logic for determining, in real-time, how to process a particular transaction request transmitted to the payment proxy from the transaction processor; and a plurality of payment connection modules coupled to the runtime payment logic for interfacing the transaction request to one of a plurality of payment verification systems.

Also disclosed herein is an E-Commerce framework, comprising: a plurality of vendor commerce systems linked to a common E-Commerce portal, wherein each vendor commerce system includes a local product catalog and a local shopping basket; a transaction processor linked to the E-Commerce portal via a computer network, the transaction processor having a global shopping basket and an interface for communicating transaction information between the local shopping baskets of the vendor commerce systems and the global shopping basket of the transaction processor; a plurality of payment verification systems for authenticating transaction requests generated by the transaction processor when a customer of the framework engages a global checkout function; and a payment proxy system coupled between the transaction processor and the plurality of payment verification systems for transmitting transaction requests generated by the transaction processor to the appropriate payment verification system.

It should be noted that these are just some of the many aspects of the present invention. Other aspects not specified will become apparent upon reading the detailed description set forth below.

Systems disclosed herein may overcome the disadvantages of presently known E-Commerce systems for aggregating multiple vendor sites, and may also provides many advantages, such as: (1) providing a common framework for vendor commerce systems while permitting the vendor systems complete control over their own product and customer data; (2) removing the logistical difficulties in dealing with back-end processing that is inherent in most E Commerce installations; (3) providing a common back-end processing interface so that vendor systems can quickly and reliable interface to the E-Commerce framework (with minor modifications to their existing system), and so that additional back-end processing functions can be easily integrated into the framework; (4) providing a unified shopping experience between multiple vendor commerce systems but retaining a single checkout process; (5) providing a unique payment proxy system for interfacing the transaction processor to a plurality of payment verification systems; and (6) providing a variety of realtime scripting commands for customizing the transaction processing of a particular merchant, or a particular customer.

Other advantages will become apparent through an understanding of the systems, methods and frameworks disclosed below. As will be appreciated, the invention is capable of other and different embodiments, and its several details are capable of modifications in various respects, all without departing from the spirit of the invention.

Accordingly, the drawings and description of the exemplary embodiments set forth below are to be regarded as illustrative in nature and not restrictive.

### BRIEF DESCRIPTION OF THE DRAWINGS

FIG. 1 is a system-level diagram of an exemplary E-Commerce architecture, including an Internet Commerce Center (“ICC”) transaction processor, an electronic mall including an E-Commerce portal and a plurality of vendor commerce systems, a payment proxy system, and other back-end processing computer systems;

FIG. 2 is a flowchart detailing several steps of a customer interacting with the exemplary E-Commerce architecture set forth in FIG. 1;

FIG. 3 is a flowchart detailing several steps carried out by the exemplary ICC transaction processor during a global checkout procedure; and

FIG. 4 is a logical block diagram showing interaction between the exemplary ICC transaction processor and payment proxy system, both shown in FIG. 1.

### DETAILED DESCRIPTION

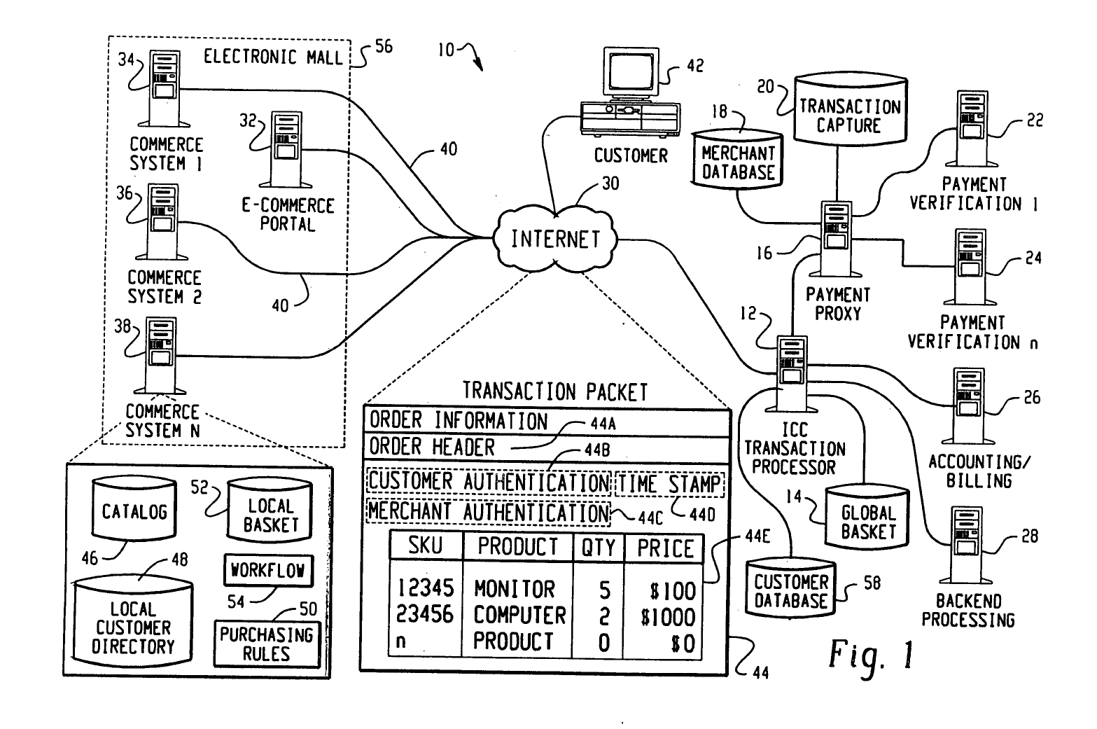

Turning now to the drawing figures, FIG. 1 sets forth a system-level diagram of an exemplary E-Commerce architecture 10. This architecture 10 (or “framework”) includes an ICC transaction processor 12 coupled to a plurality (N) of vendor commerce systems 34, 36, 38 via an electronic network 30, such as the Internet or some other type of wide-area network (“WAN”). Alternatively, the architecture could be implemented via a wide-band cable network, wireless data network, or any other type of distributed communications network.

Each of the vendor commerce systems 34, 36, 38 may include local E-Commerce elements, such as a local catalog of products 46, a local shopping basket 52, a local customer directory 48, and may also include local purchasing and workflow rules 50, 54. The local catalog of products 46 is a database maintained by the owner of the particular vendor commerce system, and includes a listing of those products that are offered for sale by the particular vendor. So, for example, a vendor of clothing products would have information identifying specific items of clothing, along with sizing, pricing and other information specific to that vendor stored in their local catalog 46, while a vendor of computer products would have similar information stored in their local catalog 46, but with respect to computer product information.

Each vendor commerce system also maintains a local shopping basket 52. This E-Commerce element (the local shopping basket 52) is used to temporarily store transaction information for the particular vendor commerce system. So, for example, if a customer connects to one of the vendor commerce systems 34, and selects a particular product for purchase, that product information and purchase information would be stored locally at vendor commerce system 34 in its local shopping basket 52. In like manner, each vendor commerce system 34, 36, 38 maintains its own local shopping basket 52 to store product and purchase information.

The vendor commerce systems, which are maintained by the owners of these systems, may also include local customer directories 48 and local workflow and purchasing rules 50, 54 that are specific to the individual vendor system. The local customer directory 48 may include information (such as a user-name and password) that controls whether a particular customer 42 can log into and purchase products from the particular vendor commerce system 34, 36, 38. The local workflow and purchasing rules 50, 54 are generally specific to each vendor, and set forth particular rules that may affect how the specific commerce system deals with certain transactions. For example, a particular customer 42 may only be authorized to make a purchase of less than $5,000, and if the items stored in the local basket 52 exceed this amount, then authorization from another individual is required. In this situation, the system can be programmed to send an email or other notification to the other individual to obtain authorization. Other, more complicated workflow and purchasing rules may be implemented within each vendor system.

Optionally, the vendor commerce systems 34,36,38 may be aggregated into an “electronic mall” 56, by coupling the vendor commerce systems 34, 36, 38 to one or more E-Commerce portal(s) 32. As shown in FIG. 1, the vendor commerce systems 34, 36, 38 are coupled to the E-Commerce portal 32 over the same electronic network 30 that is coupled to the ICC transaction processor 12. This is just one configuration of the framework, and other configurations are possible, such as by coupling the vendor commerce systems 34, 36, 38 directly to the E-Commerce portal 32, or by coupling them to the E-Commerce portal 32 by alternative electronic networks, by multiple networks, etc.

By aggregating the vendor systems through the E-Commerce portal 32, a more unified shopping experience is established. So, for example, a particular portal 32 may provide a common graphical user-interface to numerous vendor commerce systems 34, 36, 38, just like a regular mall (i.e., non-electronic) has a common interface to a set of stores that can be accessed through the common areas of the mall. Organizing the E-Commerce system 10 with the electronic mall interface 32 provides other advantages beyond the common look-and-feel that may be implemented through the E-Commerce portal 32. First, this interface provides the ability to implement and then conduct cross-vendor search functions. This can be done by providing an index into each of the vendor commerce system's catalogs 46 at the E-Commerce portal 32 (or at least accessible from the E-commerce portal). The index can then be searched (globally) so that a customer 42 can look for products across a plurality of vendors simultaneously without having to actually visit (or connect to) any of the individual vendor commerce systems 34, 36, and 38.

Second, a standard categorization scheme could be implemented through this electronic mall 56 structure. In this implementation, a standard category system would be implemented at the E-Commerce portal 32, which would be translated into more specific categories that are used by the individual vendor systems 34, 36, 38. For example, the mall 56 may include several computer manufacturers, each of which uses their own scheme for categorizing products, such as modems. One vendor may use the term “computer modems,” while another vendor may use the term “computer peripherals” to describe the same types of products. By implementing a standardized categorization scheme at the E-Commerce portal 32, the system may provide the ability to then translate a generic customer search request, such as “modem,” into a number of different categories that are more specific to the individual vendor commerce systems 34, 36, 38 that are coupled through the portal 32. This provides easier search and retrieve capabilities for the customer 42, and increases the potential that relevant products will be uncovered by the search.

The ICC transaction processor 12 provides a common gateway between the multiple vendor commerce systems 34, 36, 38 and the various back-end processing systems 22, 24, 26, 28 that are necessary to construct a viable E-Commerce solution. The ICC transaction processor 12 may include a global shopping basket 14, as well as integrated software programming for interfacing, managing and communicating with the back-end E-Commerce elements that provide payment verification, accounting/billing, order fulfillment, and any other back-end processing functions, so that these functions do not need to be implemented at each of the vendor commerce systems 34, 36, 38. This integrated software programming may take the form of a common application programming interface (“API”) that can be scaled to connect the ICC transaction processor 12 to numerous other systems and services as required. By using this common API as a means for controlling the back-end processing functions, as new systems or back-end functions are added to the E-Commerce framework, they can simply be plugged into the appropriate software hooks of the API. In this manner, as these new systems or functions are added to the common API interface, they become available to all of the vendor commerce systems 34, 36, 38 that are coupled to the ICC transaction processor 12.

Also shown in FIG. 1 is a “global” shopping basket 14, which is coupled to the ICC transaction processor 12. The global shopping basket 14 aggregates transaction information from numerous vendor commerce systems during a customer's shopping session. By providing this “global” shopping basket 14 at the ICC transaction processor 12, a customer 42 can browse, search, and purchase multiple products from multiple vendor commerce systems 34, 36, 38, and yet when the customer 42 is ready to leave the system, only a single, unified checkout is required. The ICC transaction processor 12 then manages all of the back-end transaction details, transparent to the vendor commerce systems, based on merchant-specific and/or customer-specific transaction processing rules stored, respectively, in the associated merchant database 18 and customer database 58.

The foregoing description reveals a significantly different model for conducting E-Commerce transactions than is presently known in this area, where the back-end processing functions, including payment processing, order fulfillment, accounting/billing, etc. are typically performed by the individual vendor commerce systems 34, 36, 38. By removing this logistical burden from the vendor commerce systems, the improved systems and frameworks may provide great utility over the prior art E-Commerce systems. These frameworks also provides tremendous scalability and economies of scale for each additional vendor commerce system that attaches to and communicates with the ICC transaction processor 12, since these new systems can take advantage of the advances in the integrated API at the ICC transaction processor 12 that may have been implemented or augmented for other vendor commerce systems would be part of the framework.

The vendor commerce systems 34, 36, 38 are programmed to communicate transaction information to the ICC transaction processor 12 using a universal transaction interface comprising “transaction packets” 44. These transaction packets 44 transfer information from the vendor commerce systems 34, 36, 38 to the ICC transaction processor 12 during the course of a customer's 42 interaction with the framework. The ICC transaction processor 12 then stores this information in the global basket 14, pending global checkout by the customer 42. The transaction packets 44 may include a variety of order information, such as an order header 44A and a plurality of order entries 44E that correspond to the items purchased at the particular vendor commerce system. The order header 44A may include customer authentication information 44B, merchant (or vendor) authentication information 44C or time stamp data 44D. This authentication information 44B, 44C may take a variety of forms, and may be used for a variety of purposes, such as to verify which vendor commerce system the transaction packet is coming from, to verify the customer's identity using an embedded digital signature or other types of encrypted information, or for other similar purposes.

Also included in the transaction packet are one or more order entries 44E, which indicate to the ICC transaction processor 12 what items are being purchased by the customer 42. A variety of information may be included in each order entry, such as SKU number, product identification, quantity and price, to name a few. Other items, of course, could be added to the transaction packet 44 depending on the needs of the various vendors and the specific structure of the overall framework. Alternatively, the transaction packet 44 could include a “free form” or “vendor-defined” capability to process information for specific vendors. Using this approach, the transaction packet 44 may include one or more “name value” pairs, which are free-form entry fields in the transaction packet 44 that can be customized (i.e., programmed) for a particular vendor and used for whatever back-end processing purposes are necessary for processing that particular vendor's transaction data. In this manner, although a generic (or universal) transaction interface protocol is established between the vendor systems and the common ICC transaction processor 12, a degree of customization is available so that vendor-specific transaction data can be passed to and processed by the back-end systems. As described in more detail below, this flexibility in the transaction interface augments the other vendor-specific transaction processing rules that may be stored in the merchant database 18.

By providing this universal transaction interface, a multiple vendor transaction framework may be provided in which each vendor can build and maintain their own E-Commerce system (having its own local E-Commerce elements), while at the same time “outsourcing” the back-end E-Commerce processing functions to a common transaction engine. Furthermore, by providing a global shopping basket 14 at the common transaction processor 12, a customer 42 can, in a single session, purchase items from a plurality of vendor commerce systems but only have a single checkout process for effecting the purchase of all of the selected items.

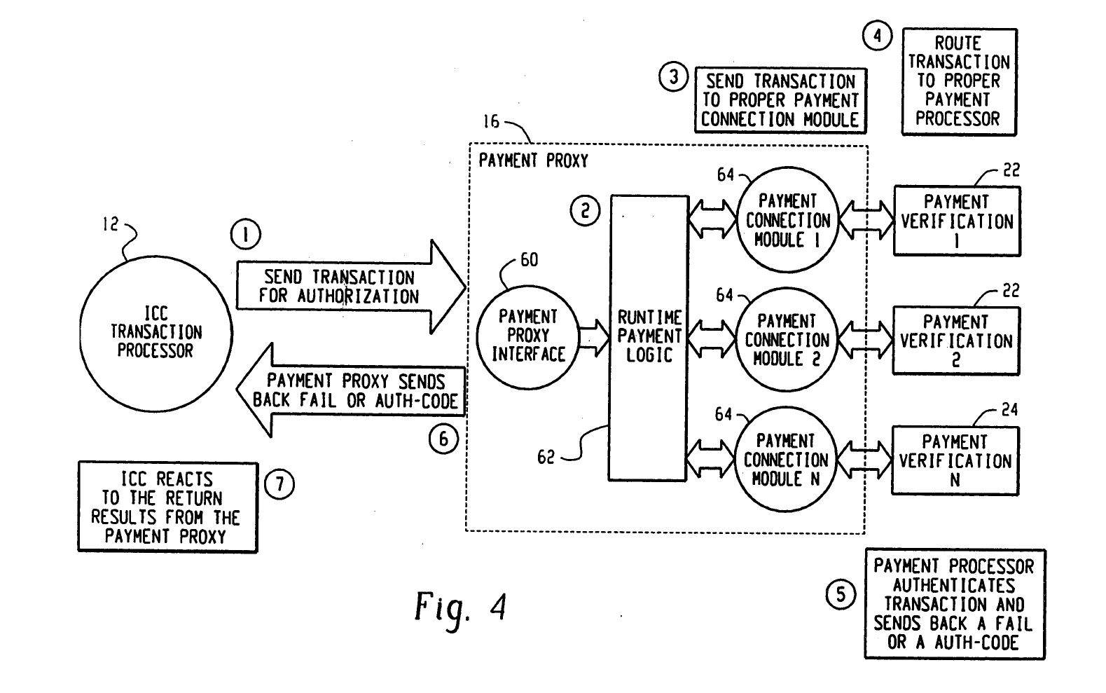

Coupled to the “back-end” of the ICC processor 12 may be several other computer systems for executing various E-Commerce functions, such as a payment proxy system 16 (which, as described in more detail in connection with FIG. 4, provides a universal interface between the ICC transaction processor 12 and a plurality of payment verification systems 22, 24), accounting/billing systems 26, and any other back-end processing systems 28 that may be necessary to provide the required E-commerce functionality, such as vendor general ledgers, order fulfillment, warehousing, shipping/receiving, customer service systems, etc. The payment proxy system 16 may also couple to a merchant database 18 and a transaction capture database 20. The merchant database 18 stores merchant-specific transaction processing information for use by the ICC transaction processor 12 in processing transaction requests for particular merchants, and the transaction capture database 20 stores information about each transaction processed through the payment proxy system 16. These elements are further described below.

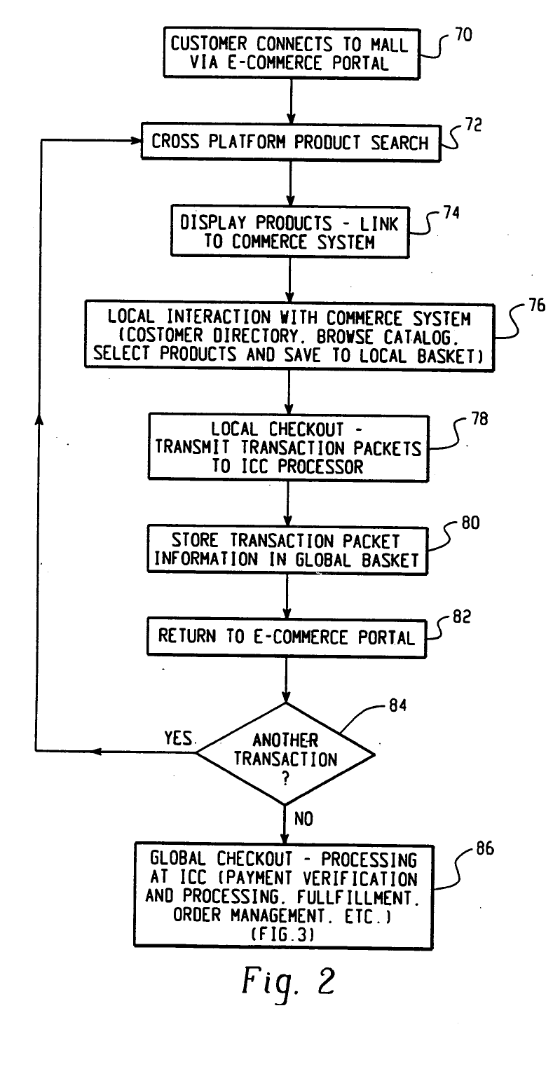

FIG. 2 is a flowchart detailing several method steps of a customer 42 interacting with the E-Commerce architecture set forth in FIG. 1. Beginning at step 70, the customer 42 connects to the Electronic Mall 56 via the E-Commerce portal 32. This connection step may be over a public packet-switched electronic network 30, such as the Internet, but may, alternatively be made by other types of electronic connections. At the E-Commerce portal 32, which may employ a common graphical user-interface (“GUI”) that is accessible through many types of browser technology, the user may select to shop from a number of vendors by simply clicking (i.e., selecting) the name of the vendor, or by selecting a graphic image on the GUI that is identified with the particular vendor. So, for example, if the customer 42 wants to buy computer equipment, a graphic of the computer vendor may be displayed at the opening page of the E-Commerce portal 32. This graphic may be a link (such as a hypertext link coded in HTML or XML) that connects the user directly to the particular vendor commerce system.

Alternatively, and as described above, the E-Commerce portal 32 may include a searchable cross-vendor index that includes listings of all (or some) of the products being sold by all (or some) of the vendors connected through the E-commerce portal 32. Thus, in step 72, a customer 42 may conduct a cross-vendor product search of this index in order to locate one or more vendors that carry the particular product (or type of product.) Having conducted this type of search, the E-Commerce portal 32 then displays a listing of products/vendors that meet the search criteria. This listing might include hypertext (or other types of) links to take the customer directly to the relevant vendor commerce system 34, 36, 38, or directly to the product description stored in the local catalog 46.

Whether through a manual search, or an automatic search/retrieval step, at some point (step 74) the E-Commerce portal 32 provides a display of products or vendors that includes links to the vendor's commerce systems 34, 36, 38. The customer 42 then selects one of these links and is connected directly to the particular system. At step 76 of the method, the customer 42 then interacts with the vendor's commerce system by, for example, entering a user-name and password for verification with the local customer directory 48, conducting a local search and retrieval operation on the local catalog 46, and selecting product(s) for purchase by saving this information to the systems' local shopping basket 52. During this interaction with the vendor's system, local workflow and purchasing rules 50, 54 can be applied to the attempted transaction as required. As long as the customer wants to purchase more products, this local process can continue at the vendor's system, with additional purchase information being stored at the local shopping basket 52.

When the customer is done shopping at a particular vendor commerce system, a local checkout step is performed 78, in which one or more transaction packets 44 are constructed at the vendor commerce system and then transmitted over the network 30 to the ICC transaction processor 12, where this information is stored in the global shopping basket 14 at step 80. As described above, this transaction packet 44 may include order header information 44A, such as customer authentication data 44B, merchant authentication data 44C, a time stamp 44D, and a plurality of order entry items 44E that describe the purchased items. Alternatively, during a local shopping process at one of the vendor commerce systems 34, 36, 38, a transaction packet 44 can be generated and transmitted to the ICC transaction processor 12 as each new item is purchased.

When the customer 42 has finished at a particular vendor commerce system 34, 36, 38, a link is then provided at step 82 (such as an HTML link or “portal” graphic at the vendor's system) in order to navigate the customer 42 back to the E-Commerce portal 32. At step 84, the customer 42 decides whether or not to conduct more transactions or to checkout and purchase the selected products. If the customer 42 wants to buy more products, then additional manual or automatic search/retrieval steps can be conducted at the E-Commerce portal 32 by returning to step 72, where the entire shopping process at the local vendor system (steps 72-84) is repeated until the customer 42 decides to conduct a global checkout. Note that as the customer 42 is linked to other vendor commerce systems to purchase additional products, additional transaction packets 44 are transmitted to the ICC transaction processor 12, where they are stored in the global basket 14. In this manner, the global basket 14 may include transaction data from numerous vendor commerce systems 34, 36 and 38.

Finally, at step 86, the customer 42 selects the global checkout option at the E-Commerce portal 32, which then transmits a signal to the ICC transaction processor 12 indicating that the customer is ready to finalize the shopping session. The ICC transaction processor 12 then prompts the E-Commerce portal 32 for customer-specific payment verification information, such as a credit-card number and expiration date, customer authentication information, or other information used to verify the authenticity of the purchase. The ICC transaction processor 12 then authorizes the transaction with one or more payment verification systems 22, 24, advantageously through the intermediary payment proxy system 16, which, as described in more detail below, operates as an interface between the ICC transaction processor 12 and numerous payment verification systems 22, 24.

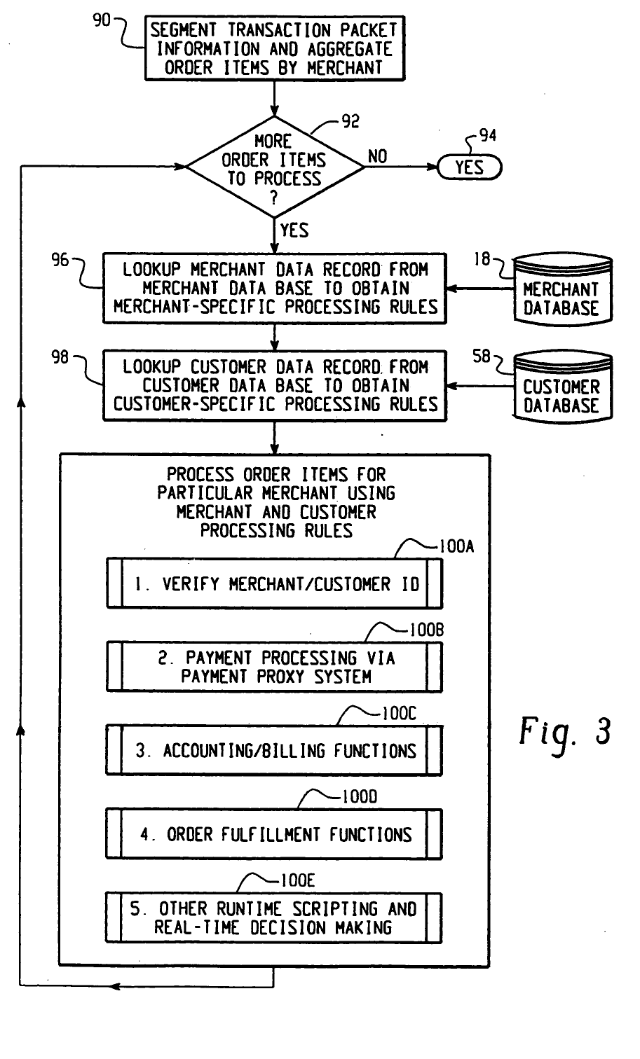

Assuming that the transaction is authorized, the ICC transaction processor 12 then engages one or more back-end processing functions, such as communicating with an accounting/billing system 26, or other back-end systems 28, such as an order fulfillment system, customer service system, etc. In this manner, payment verification, accounting/billing, order fulfillment, and any other necessary back-end processing functions can be aggregated across multiple vendors and these functions can be centralized to a common transaction processing system and shared amongst multiple vendors, thereby alleviating the individual vendors from having to manage these logistical functions, and at the same time providing the customer 42 with an integrated one-stop E-Commerce shopping experience. These back-end processing functions, which may be implemented and managed through the common API operating at the ICC transaction processor 12, are described in more detail in FIG. 3.

FIG. 3 is a flowchart detailing several method steps carried out by the exemplary ICC transaction processor during a global checkout procedure. At step 90, the ICC transaction processor 12 queries the global basket 14 and segments the transaction packet information stored there for the particular customer session into a plurality of individual transaction order items 44E, and then aggregates all of the transaction order items 44E by merchant. This step results in a plurality of transaction order items that are grouped by merchant for processing according to the specific transaction processing rules of the particular merchant. At step 92, the system 12 determines if all of the transaction order items have been processed for the particular customer session. If so, then the back-end global checkout process ends at step 94. If not, then the back-end system 12 loops through steps 96-100 (the transaction processing steps) until all of the transaction order items have been processed.

Turning now to the specific transaction processing steps, at step 96, the ICC transaction processor 12 queries the merchant database 18 in order to obtain the merchant-specific transaction processing rules. Each merchant (or vendor) can have their own specific rules setup for determining how their transactions are processed by the common back-end system 12. In this manner, although the ICC transaction processor 12 is common to all of the participating vendor commerce systems 34, 36, 38, each vendor commerce system can have a customized back-end processing scheme. Merchant-specific data processing rules stored in the merchant database 18 may include: (1) merchant authentication information or a merchant account number; (2) preferred payment processor information, such as what payment verification system to use for transactions; (3) order fulfillment instructions; (4) accounting/billing instructions; and (5) other merchant-specific rules, including, optionally, certain merchant-specific runtime scripting algorithms.

The merchant-specific runtime scripting algorithms add a measure of real-time decision making and flexibility to the ICC transaction processor 12 that is unknown in the prior art E-Commerce systems. For example, a merchant may desire to have implemented a more sophisticated methodology for determining what payment verification system 22, 24 to use for its transactions. The merchant may be concerned primarily about speed of processing, and secondarily concerned about cost. In this situation, a flexible, re-programmable runtime script can be included with the merchant-specific processing information stored in the merchant database 18 that interactively determines (through the payment proxy 16) which payment verification systems are operating most efficiently (i.e., fastest turn-around time), and then determines for those that are operating quickly, which system is the cheapest. Or the script may simply be designed to select the cheapest system, or the fastest, or selected based on some other criterion that is important to the particular merchant. The same type of scripting function may be implemented between the ICC transaction processor 12 and the accounting/billing system 26 or any of the other back-end processing systems 28 in order to create a real-time back-end processing environment that is designed based on the requirements of the particular merchant.

After the ICC transaction processor 12 has obtained the merchant-specific rules, at step 98 it queries the customer database 58 in order to obtain any customer-specific transaction processing rules. Although these customer-specific rules may take a variety of forms, these rules will generally include a customer account number (for verification purposes) and one or more runtime scripts for providing interactive feedback about the processed transactions to the customer's system 42. For example, the customer system 42 may be operating some type of enterprise system software coupled to a purchasing system for tracking purchased items. In this situation, a runtime script can be stored at the customer database 58 and processed by the ICC transaction processor 12 at the time that relevant transaction items are processed. In this manner, information regarding actual purchases that are committed by the system 10 can be transmitted back to the customer's system 42 in a format that is compatible with the customer's purchasing software system. Other types of runtime scripting algorithms could certainly be implemented between the ICC transaction processor 12 and the customer's system 42.

Having obtained the merchant-specific rules at step 96 and the customer-specific rules at step 98, the ICC transaction processor 12 then processes the various transaction order items associated with the particular merchant at step 100, and, using the common transaction API implemented at the ICC 12, communicates the appropriate processing information to and from the various back-end processing systems. These processing steps may include: (1) verifying the merchant and customer identification information against that stored in the databases 18, 58; (2) conducting payment verification functions via the payment proxy (and perhaps according to a runtime payment verification script obtained from the merchant database 18); (3) carrying out accounting/billing functions and communicating with the appropriate account/billing back-end processing system, which may be co-located with the ICC transaction processor 12, or which may be located at some other place, (4) carrying out order fulfillment functions so that the correct product(s) get shipped to the right location; and (5) executing any other runtime scripts (either merchant-specific or customer-specific) that may have been obtained from either the merchant database 18 or the customer database 58. The system then loops back to step 92 to process additional transaction order items for another merchant.

FIG. 4 is a logical block diagram showing an interaction between the exemplary ICC transaction processor 12 and payment proxy system 16 shown in FIG. 1. The payment proxy system 16 provides a universal payment verification interface between the ICC transaction processor 12 and a plurality of payment verification systems 22, 24. Although described in the context of FIG. 1, the payment proxy system 16 can be used with a variety of different frameworks and different E-Commerce systems, and is not limited to the system shown in FIG. 1.

The payment proxy system 16 may include a front-end payment proxy interface module 60, runtime payment logic 16, and a plurality of payment connection modules 64. As shown in FIG, 1, the payment proxy system 16 is also coupled to a merchant database 18 and a transaction capture database 20. The elements of the payment proxy system 16 may be implemented via software instructions stored within the payment proxy system 16, but could, alternatively be implemented in hardware or a mix of hardware and software instructions. The software instructions for carrying out the functionality of the payment proxy could be programmed using a variety of different programming techniques and using a variety of different programming languages as those of skill in this art will appreciate.

The basic purpose of the payment proxy system 16 is to provide a universal payment verification interface between one or more transaction processing systems (or other E-Commerce systems) and a plurality of payment verification hosts. In this manner, flexible and efficient payment verification services can be provided to a plurality of E-Commerce systems, without any need for the E-Commerce systems to know the details of communicating with and effecting transactions with the payment verification systems. Such a universal E-Commerce payment verification interface is unknown in the prior art.

Operationally, the exemplary payment proxy 16 works as follows. At step 1 (FIG. 4), the ICC transaction processor 12 (or other E-Commerce system) sends a particular transaction for payment authorization. This information is communicated to the payment proxy interface 60 using a software programmed API that provides a universal interface to E-Commerce systems. As with the other communication APIs noted above, this software programming can take a variety of different formats, and may be programmed using a variety of different programming techniques and languages, which would be apparent to one of skill in this field. The importance of the interface API's is that they provide a common language that can be provided to other E-Commerce systems and merchants to enable them to interface their systems to the framework shown in FIG. 1 and the payment proxy system 16 shown in FIG. 4. The interface to the payment proxy 16 might utilize HTTP or HTTPS packets, although many other interface techniques could be used, such as, for example, CIP, Sockets, or RPC, to name but a few.

At step 2, the payment proxy 16 executes the runtime payment logic 62 in order to determine how to process the particular transaction authorization request. The runtime payment logic 62 can take many forms and can operate many functions, in addition to simply determining where to route the particular transaction request. For example, various business rules particular to a certain merchant could be executed by the runtime payment logic. These business rules may take the form of scripting information that is stored in the associated merchant database 18. As described above, the merchant database 18 may include a variety of runtime scripts for instructing the E-Commerce system how to process the transactions for a particular merchant. It is the payment proxy's runtime payment logic 62 that executes these stored scripting commands to, for example, determine which payment verification system 22, 24 is operating most efficiently, or most inexpensively, etc., and then to route the transaction authorization based on the results of this determination. Many other real-time processing functions could also be implemented by the runtime payment logic 62, such as, for example, applying additional calculations to a particular order; interfacing information with an associated order fulfillment system; sending transaction alerts or other messages to an e-mail or pager system when certain products are purchased, certain price thresholds are exceeded, etc.; or to interface with other databases to either receive or update legacy data.

Having determined how to process the particular transaction authorization request, the payment proxy 16, at step 3, then sends the transaction to the proper payment connection module 64. The payment connection modules 64 each provide interface programming for instructing the payment proxy 16 how to communicate with the plurality of payment verification systems 22, 24. At step 4, the transaction authorization is routed to the proper payment verification system. The payment processor then authenticates the transaction request at step 5 and transmits back to the payment proxy system 16 a failure code (indicating that the transaction was not authorized), or an “auth-code” (indicating that the transaction was authorized.) The payment proxy 16 then routes the code back to the ICC transaction processor 12 (or other E-Commerce system) at step 6, which, at step 7, then reacts to the code by, for example, sending a message to the customer indicating whether the transaction has failed or has been authorized.

As noted above, the payment proxy system 16 may be coupled to a merchant database 18 and a transaction capture database 20. The merchant database 18 stores merchant-specific transaction processing information such as the aforementioned runtime scripts, and may also include other merchant-specific payment processing information as described above. The transaction capture database 20 is used by the payment proxy system 16 to store information regarding all transaction authorization requests that pass through the system 16. This is done mostly for reporting purposes.

The embodiments described with reference to the drawing figures are presented only as examples of the present invention, which is limited only by the claims. Other elements, steps, methods and techniques that are insubstantially different from those described herein are also within the scope of the invention.

1. A transaction processor operable to receive product selections from a plurality of vendors and assist a purchase operation utilizing a unified checkout step, comprising:
facilities for connecting to an electronic communication network;
a transaction interface operable to receive customer product selections over the network from a plurality of vendor commerce systems apart from the transaction processor; and
at least one global shopping basket operable to store received product selections from the plurality of vendor commerce systems, the product selections selected from a customer, the global shopping basket further maintaining a vendor identifer for each stored product selection such that a vendor may be identified for each selection.

2. A transaction processor according to claim 1, wherein the transaction processor includes no shopping facilities to customers.

3. A transaction processor according to claim 1, further comprising one or more objects for initiating a purchase transaction of items contained in the global shopping basket.

4. A transaction processor according to claim 3, further comprising an interface to a customer database containing customer-specific transaction processing rules that instruct the transaction processor how to process a transaction for a particular customer.

5. A transaction processor according to claim 3, further comprising:
a plurality of payment verification systems for authenticating transaction requests generated by the transaction processor when a customer of the system engages a global checkout function; and
a payment proxy system coupled between the transaction processor and the plurality of payment verification systems for transmitting transaction requests generated by the transaction processor to the appropriate payment verification system.

6. An E-Commerce system according to claim 5, wherein the payment proxy system includes:
a payment proxy interface for communicating information to and from the transaction processor;
runtime payment logic for determining, in real-time, how to process a particular transaction request transmitted to the payment proxy from the transaction processor; and
a plurality of payment connection modules coupled to the runtime payment logic for interfacing the transaction request to one of a plurality of payment verification systems.

7. An E-Commerce system according to claim 3, further comprising:
an accounting/billing system; and
one or more order fulfillment systems.

8. A vendor commerce system for an E-Commerce system operational over a network, the E-Commerce system including a global checkout function, the vendor commerce system comprising:
electronic facilities for electronic communication over the network;
a vendor-specific catalog of products;
a vendor presentation engine operable to present products from the vendor-specific catalog to customers and to and to receive customer product selections, both through the electronic facilities for electronic communication over the network;
a local shopping basket for storing the customer product selections; and
a transaction interface operable to communicate the product selections from the local shopping basket to a global shopping basket maintained in a network entity apart from the vendor commerce system, the global shopping basket being capable of storing product selections from more than one vendor and identifying the vendor of each stored selection.

9. A vendor commerce system according to claim 8, wherein the vendor commerce system includes no facilities for purchase of selected products in the local shopping basket.

10. A vendor commerce system according to claim 8, wherein the network entity apart from the vendor commerce system is a transaction processor.

11. An E-Commerce system including a vendor commerce system according to claim 8, wherein the E-Commerce system further comprises a transaction processor connected to an electronic communication network, said transaction processor including a global shopping basket, an interface for receiving product selections from a vendor commerce system, and one or more objects for initiating a purchase transaction of items contained in the global shopping basket.

12. An E-Commerce system according to claim 11, further comprising a customer database coupled to the transaction processor, wherein the customer database stores customer-specific transaction processing rules that instruct the transaction processor how to process a transaction for a particular customer.

13. An E-Commerce system according to claim 11, wherein the E-Commerce system further comprises:
a plurality of payment verification systems for authenticating transaction requests generated by the transaction processor when a customer of the system engages a global checkout function; and
a payment proxy system coupled between the transaction processor and the plurality of payment verification systems for transmitting transaction requests generated by the transaction processor to the appropriate payment verification system.

14. An E-Commerce system according to claim 13, wherein the payment proxy system includes:
a payment proxy interface for communicating information to and from the transaction processor;
runtime payment logic for determining, in real-time, how to process a particular transaction request transmitted to the payment proxy from the transaction processor; and
a plurality of payment connection modules coupled to the runtime payment logic for interfacing the transaction request to one of a plurality of payment verification systems.

15. An E-Commerce system according to claim 13, further comprising:
an accounting/billing system; and
one or more order fulfillment systems.

16. A method of conducting E-Commerce comprising the steps of:
providing a vendor commerce system on a customer-acessible electronic network;
maintaining a vendor-specific catalog of products accessible to the vendor commerce system;
presenting, from the vendor commerce system, the vendor specific catalog of products to customers;
receiving from customers product selections;
placing product selections in a local shopping basket;
communicating the product selections in the local shopping basket to a global shopping basket located in a network entity apart from the vendor commerce system through a transaction interface, the global shopping basket being capable of storing product selections from more than one vendor and identifying the vendor of each stored selection.

17. A method according to claim 16, wherein the network entity apart from the vendor commerce system is a transaction processor.

18. A method according to claim 16, further comprising the steps of:
maintaining a transaction processor;
receiving, by the transaction processor, product selections from customers previously stored in local shopping baskets maintained in vendor commerce systems; and
storing the received product selections in a global shopping basket while maintaining an identifier of a vendor for each received selection.

19. A method according to claim 18, further comrising the steps of:
aggregating and segmenting the selections stored in a global shopping basket by vendor; and
processing the individual product order idems for each vendor in a global checkout step.

20. A method according to claim 18, further comprising the steps of:
accessing a customer database containing customer-specific transaction processing rules; and
processing the order of a customer according to the customer-specific transaction processing rules relating to the particular customer, the order including product selections from a plurality of vendors.

21. A method according to claim 18, further comprising the steps of:
authenticating transaction requests generated by the transaction processor; and
utilizing at least one of a plurality of payment verification systems.

22. A method of communicating E-commerce information, comprising the steps of:
operating an electronic communication network, the network operating as a conduit for the transit of data between sources and destinations, the sources and destinations not necessarily adjacently connected to the network;
transiting over the network the contents of a vendor-local shopping basket containing customer product selections to a network object maintaining global shopping baskets;
transiting over the network an indication from a customer that a global checkout operation is to commence of the items contained in a global shopping basket; and
transiting over the network customer-specific information to complete the purchase transaction.

23. A method according to claim 22, further comprising the step of transiting over the network a transaction for payment authorization to a payment proxy system.

24. A method according to claim 22, further comprising the step of transiting to a customer a message indicating whether a transaction has failed or has been authorized.

25. A method according to claim 22, further comprising the step of transiting authorization communications with a payment verification host.

26. A method according to claim 22, further comprising the step of authenticating a purchase using customer-specific information.
